(19) United States
(12) Patent Application Publication
(10) Pub. No.: US 2013/0268567 A1
(43) Pub. Date: Oct. 10, 2013

(54) System And Method For Updating Slowly Changing Dimensions

(71) Applicants: Frank Adjei-Banin, Little Ferry, NJ (US); Rosa Antonini, Fort Lee, NJ (US); Andrew Wilson, Astoria, NY (US); Philip James, New York, NY (US)

(72) Inventors: Frank Adjei-Banin, Little Ferry, NJ (US); Rosa Antonini, Fort Lee, NJ (US); Andrew Wilson, Astoria, NY (US); Philip James, New York, NY (US)

(73) Assignee: Cover-All Technologies, Inc., Fairfield, NJ (US)

(21) Appl. No.: 13/440,485

(22) Filed: Apr. 5, 2012

(51) Int. Cl. G06F 17/30

(52) U.S. Cl. 707/812; 707/E17.005

(57) ABSTRACT

A dimension table is populated with data records extracted from at least one source system with each data record being associated with identifying hash values and attribute hash values. Once the dimension table is established, a set of hash values is computed for an incoming set of data records. The incoming set of hash values may include at least one identifying hash value and at least one attribute hash value for each data record contained in the incoming set of data records. The method then searches the established dimension table for records having an identifying hash value identical with the identifying hash value of the incoming set of data records. Once a match is found, the method compares the attribute hash values of the records having the identical identifying hash values. If the attribute hash values are different, the method updates the dimension table with the incoming data record.

### BACKGROUND

Dimension is a term in data management and data warehousing that refers to logical groupings of data such as geographical location, customer information, or product information. Slowly Changing Dimensions (SCDs) are dimensions that have data that changes slowly, rather than changing on a time-based, regular schedule. There are several methodologies (Type 0-6) for maintaining data changes in a SCD but Type 1, Type 2 and Type 3 are the most common.

Under Type 1 methodology, the data warehouse does not preserve historical information and the existing information is overwritten with the incoming current value for attributes contained within a load file.

Under Type 2 methodology, the history of changes in a load file is recorded by creating a new row in the dimensional table. As shown in FIG. 1, a dimension modeled to capture Type 2 data changes typically consists of: surrogate key, a natural key, a row start date, a row end date, a most recent row indicator (current flag) and dimension attributes. For a given natural key, a change to these dimension attributes is detected and a new row is inserted into the dimension table with a new surrogate key. The row start date, row end date and most recent row indicator for the prior and new version of the rows are adjusted to reflect the new version of the record for the natural key.

With a Type 3 change, another attribute is added to the existing dimension row in the dimension to support analysis based on either the new or the prior attribute value.

The Type 2 methodology is the focus of this disclosure and is considered a standard technique for accurately tracking changes to dimensional tables in a data warehouse. As discussed above, the Type 2 SCD tracks historical data by creating multiple records for a given natural key in the dimensional table. In this type of SCD, the dimension may have unlimited history preservation as a new record is inserted each time a change is made.

When using a Type 2 SCD, data is typically stored in a data warehouse. The data warehouse is designed to contain historical information organized in structures suitable for reporting and analysis. To provide efficient analysis and reporting, the information model is typically organized according to the major aspects and measures of a business. That is, the dimension may represent an aspect of the business which is of prime interest for analysis and reporting purposes. For example, in the insurance business domain, typical examples of dimensions include: Line of Business, Product, Coverage, Policy, Time Period and others.

The other important part of the information model deals with measures. An organization typically has data (facts) about the aspects of its business in which it is interested in reporting and analyzing. These facts are reported and analyzed by aspects or dimensions of a business. Following the insurance business domain, the examples of facts include: Gross Written Premium, Loss Ratio, Acquisition Costs, Expense Ratio and others.

### SUMMARY

The disclosed technology relates to a data warehouse environment and in particular to a Type 2 slowly changing dimension table in a data warehouse or a data mart environment. The disclosed technology outlines a method to identify, capture and deliver a change for a Type 2 slowly changing dimension in a data warehouse environment.

One aspect of the disclosed technology relates to a computer-implemented method for updating a slowly changing dimension table. The dimension table may be a Type 2 slowly changing dimension table and may be populated with data records extracted from at least one source system. Each data record may be associated with at least one identifying hash value and/or at least one attribute hash value.

After the dimension table is established, the computer-implemented method computes a set of hash values for an incoming set of data records extracted from the at least one source system. This computing operation may be performed by a collision-free hashing algorithm and may compute at least one identifying hash value and at least one attribute hash value for each data record contained in the incoming set of data records. The at least one identifying hash value may be a hash of a source natural key for a dimension and the at least one attribute hash value may be a hash of non-key attributes of a dimension.

After the hash values are computed, the computer-implemented method then searches the established dimension table for records having an identifying hash value that is identical to the identifying hash value of the incoming set of data records. Once a match is found, the method will compare the attribute hash values of the records having the identical identifying hash values. If the attribute hash values are different, the method updates the dimension table with the incoming data record.

The computer-implemented method may also include a hash table that is populated with a current hash table, a previous hash table and a new hash table. The current hash table may store hash values for all records associated with the incoming data record, the previous hash table may store hash values for all records populated on the dimension table and the new hash tables may stores a change in hash values that results from the comparison of the current hash table with the previous hash table. Using the above hash tables, the method may compile a list wherein a change was shown between the current hash value and the previous hash value. This list will then be used in conjunction with the searching step discussed above.

Another aspect of the disclosed technology relates to a system for updating a slowly changing dimension table. The dimension table may be a Type 2 slowly changing dimension table and may be populated with data records extracted from at least one source system. Each data record may be associated with at least one identifying hash value and at least one attribute hash value. The system may include one or more processors and one or more computer-readable storage mediums containing instructions configured to cause the one or more processors to perform operations.

After the dimension table is established, the operations compute a set of hash values for an incoming set of data records extracted from the at least one source system. This computing operation may be performed by a collision-free hashing algorithm and may compute at least one identifying hash value and at least one attribute hash value for each data record contained in the incoming set of data records. The at least one identifying hash value may be a hash of a source natural key for a dimension and the at least one attribute hash value may be a hash of non-key attributes of a dimension.

After the hash values are computed, the system then searches the established dimension table for records having an identifying hash value that is identical to the identifying hash value of the incoming set of data records. Once a match is found, the system will compare the attribute hash values of the records having the identical identifying hash values. If the attribute hash values are different, the system updates the dimension table with the incoming data record.

The system may also include a hash table that is populated with a current hash table, a previous hash table and a new hash table. The current hash table may store hash values for all records associated with the incoming data record, the previous hash table may store hash values for all records populated on the dimension table and the new hash tables may stores a change in hash values that results from the comparison of the current hash table with the previous hash table. Using the above hash tables, the system may compile a list wherein a change was shown between the current hash value and the previous hash value. This list will then be used in conjunction with the searching step discussed above.

Another aspect of the disclosed technology relates to a computer-program product for updating a slowly changing dimension table. The dimension table may be a Type 2 slowly changing dimension table and may be populated with data records extracted from at least one source system. Each data record may be associated with at least one identifying hash value and at least one attribute hash value.

The product may be tangibly embodied in a machine-readable storage medium that includes instructions configured to cause a data processing apparatus to compute a set of hash values for an incoming set of data records extracted from at least one source system. This computing operation may be performed by a collision-free hashing algorithm and may compute at least one identifying hash value and at least one attribute hash value for each data record contained in the incoming set of data records. The at least one identifying hash value may be a hash of a source natural key for a dimension and at least one attribute hash value may be a hash of non-key attributes of a dimension.

After the hash values are computed the data processing apparatus may then search the dimension table for records having an identifying hash value that is identical to the identifying hash value of the incoming set of data records. Once a match is found, the data processing apparatus will compare the attribute hash values of the records having the identical identifying hash values. If the attribute hash values are different, the data processing apparatus updates the dimension table with the incoming data record.

The product may also include a hash table that is populated with a current hash table, a previous hash table and a new hash table. The current hash table may store hash values for all records associated with the incoming data record, the previous hash table may store hash values for all records populated on the dimension table and the new hash tables may stores a change in hash values that results from the comparison of the current hash table with the previous hash table. Using the above hash tables, the data processing apparatus may compile a list wherein a change was shown between the current hash value and the previous hash value. This list will then be used in conjunction with the searching step discussed above.

### BRIEF DESCRIPTION OF THE DRAWINGS

FIG. 1 is a table showing column types and descriptions for a conventional data capture dimension model;

FIG. 2 is a diagram illustrating an aspect of the disclosed technology;

FIG. 3 is a flow chart showing a data flow from pre-staging to staging for a parent dimension;

FIG. 4a is a table showing column types and descriptions for a data capture dimension model for a parent dimension of the disclosed technology;

FIG. 4b is a table showing column types and examples for a data capture dimension model for a parent dimension of the disclosed technology

FIG. 5 is a flow chart showing a data flow from pre-staging to staging for a child or associate entity dimension;

FIG. 6 is a table showing column types and descriptions for Current, Previous and New Hashes tables;

FIG. 7a is a table showing column types and descriptions for a data capture dimension model for a child dimension of the disclosed technology;

FIG. 7b is a table showing column types and examples for a data capture dimension model for a child dimension of the disclosed technology;

FIG. 8a is a table showing column types and descriptions for a data capture dimension model for an associative entity of the disclosed technology;

FIG. 8b is a table showing column types and examples for a data capture dimension model for an associative entity of the disclosed technology;

FIG. 9 is a table showing a conventional SCD methodology;

FIG. 10 is a table showing a SCD methodology for a parent dimension in the disclosed technology;

FIG. 11 is a table showing a SCD methodology for a child dimension in the disclosed technology;

FIG. 12 is a table showing a SCD methodology for an associative entity in the disclosed technology;

FIG. 13 is a table showing current hashes, previous hashes and new hashes for the disclosed technology;

FIG. 14 is a table showing column types and descriptions for a data capture dimension model for a parent dimension in a data warehouse of the disclosed technology;

FIG. 15 is a table showing column types and descriptions for a data capture dimension model for a child dimension in a data warehouse of the disclosed technology;

FIG. 16 is a table showing column types and descriptions for a data capture dimension model for an associative entity in a data warehouse of the disclosed technology;

FIG. 17 is a flow chart showing a data flow from Staging to Data Warehouse for a parent dimension; and

FIG. 18 is a flow chart showing a data flow from Staging to Data Warehouse for a child or associate entity dimension.

### DETAILED DESCRIPTION

The disclosed technology provides a method based on data hashing techniques that is capable of detecting any changes between two near identical data sets and create a new version of the data set in a dimension or reference table.

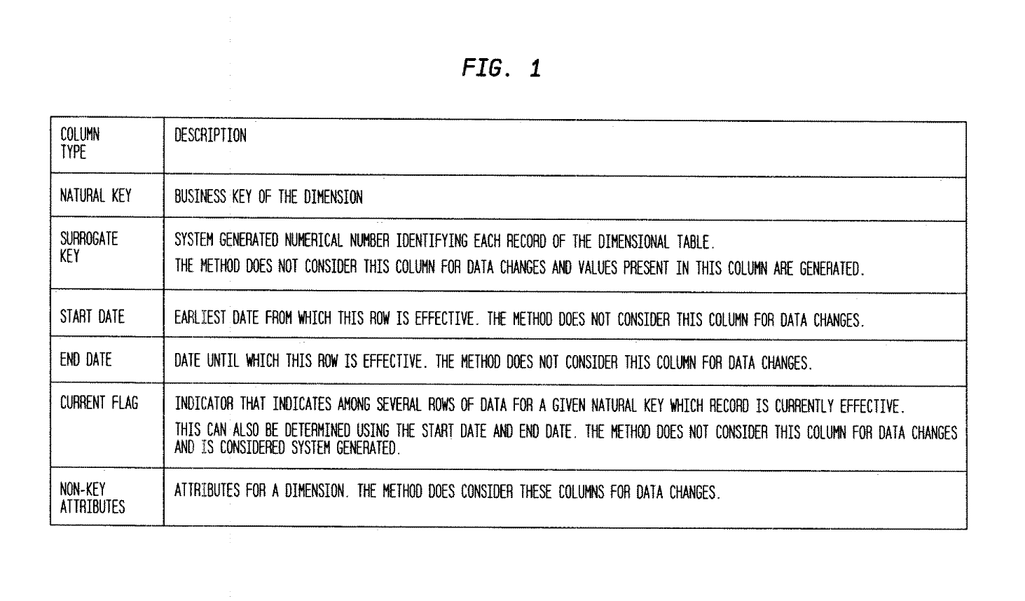

As shown in FIG. 1, a dimension as modeled in a data warehouse will typically consist of a natural key and non-key business attributes. A natural key (or a business key) uniquely identifies an aspect of the business. For example, in a Policy Type dimensional table, the Policy Type Code can be a candidate for a natural key while Policy Type Name and Policy Type Description are non-key attributes of the Policy Type dimensional table.

In a data warehouse, changes occurring to the non-key dimension attributes for a given natural key are of prime interest. The natural key is used to identify an instance of a dimensional entity and is assumed not to change over the time. For the purpose of this invention, the Type 2 methodology is used to maintain the history of these changes. As a result, additional records are added to a dimensional table whenever a change is detected for the non-key business attributes. Using the Type 2 methodology, a dimension table is typically modeled as indicated in FIG. 1. For example, a conventional dimension table may have column types that include natural key, surrogate key, start date, end date, current flag and non-key attributes.

A dimensional table in data warehouse represents an aspect of the business and is mapped to one or more tables (representing business entities) in the source systems. It is not uncommon that a dimension will be mapped to one or more entities of the source system. As a result, it is also very common for a dimension to have a natural key which is composed of one or more attributes (a composite key) sourced from the various entities in the source system. Irrespective of its composition, the natural key should uniquely identify a business aspect and the dimensional table should allow for storing various versions of this aspect. The record currently effective in a dimension is identified with the following condition: Current Flag=‘Y’ and End Date is NULL. Both the currently effective and all historical versions of a record for a given natural key are stored in the same reference or dimension table.

A data warehouse typically loads data received from various heterogeneous source systems. These source systems contain data in a structure designed for a source system (transaction or operational). That is, a source system will typically extract data to be loaded into a data warehouse. This extraction, commonly known as the push method, conforms the data to an enterprise wide integration format. The enterprise wide integration format, known as pre-staging layer, is the first formatting of data between the various source systems and a data warehouse system. The pre-staging data layer represents a conformed model for various transaction and operational systems. The process that moves data from the pre-staging to a staging layer transforms data into a format suitable for reporting and analytical purposes. In addition, any other logical transformation, unifying of data elements, and data cleansing can be performed during this transport process.

Data is transported from several pre-staging databases to the staging area. The staging area holds data received from multiple source systems. The purpose of the staging area is to prepare the data consistently for loading into the data warehouse. The staging and data warehouse layers use the same logical data model. However, the physical data models for each of these layers differ in structure to support the generic method of data versioning.

Any Type 2 slowly changing dimension implementation requires a “change data capture” system in the ETL process. To simplify the data flow in the ETL process, it is expected that the source system will provide a logical unit of change instead of changes for each table. A logical unit of change is defined as extracting data for all related tables. For example, in an insurance policy administration source system, it is expected that the source system will deliver a complete policy even if coverage or its limit has changed. In a worst case scenario, a source system does not have capability to provide the changed data and does not date stamp its own updates. In this case, a full feed of data is provided. This invention assumes the worst case scenario and outlines a “change data capture” method that is suitable for both incremental and full data feeds received from the source systems.

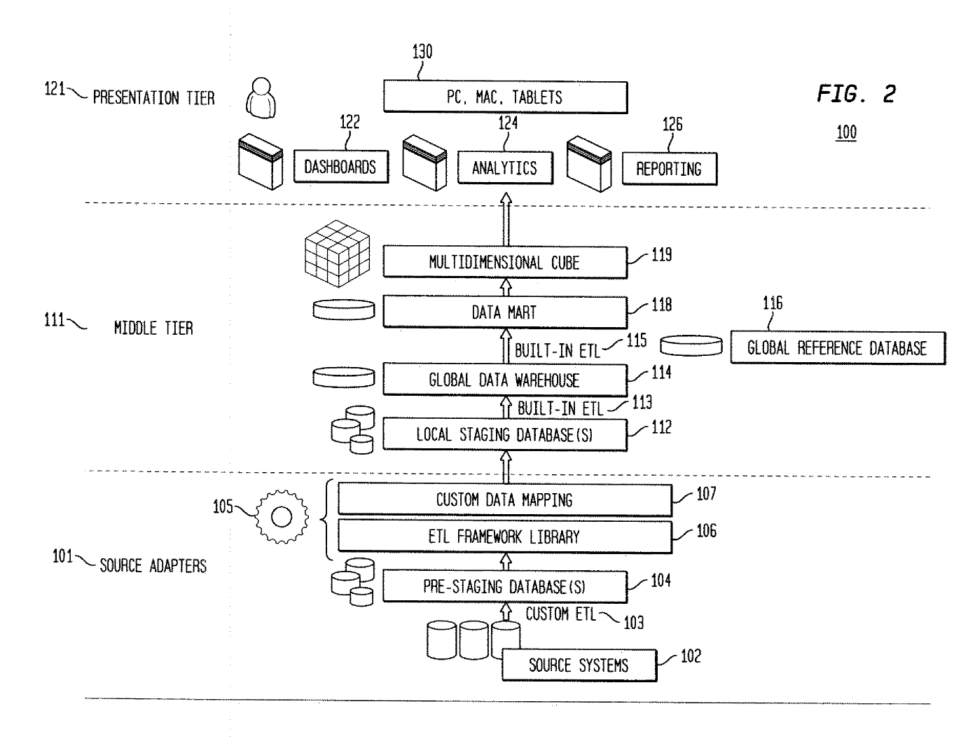

FIG. 2 shows high level architecture of a system 100 employing the disclosed technology. The system can be separated into three categories, source adapters 101, middle tier 111 and presentation layer 121. The source adapters 101 are capable of scouring data from various source systems 102 and mapping the data, the middle tier 111 is capable of transforming the source system data into an accessible and actionable business information format and the presentation layer 121 presents the business information to a user in a suitable fashion.

The source adapters 101 include various source systems 102, a pre-staging database 104 and an ETL processor 105. The source systems 102 typically represent online transaction processing system databases. These source systems 102 will be the data that is eventually loaded into a data warehouse 114 as will be discussed more fully below.

Once the system 100 obtains the needed data from the source systems 102, the data will be loaded into the pre-staging database 104. A pre-staging database 104 is typically created for each source system 102. The pre-staging database 104 acts as an “as is” repository for storing full or incremental source data based on capabilities of the source systems. This loading step may also accelerate data retrieval from the source systems 102 and may reduce the time frame needed to access the source systems 102. The structure of these pre-staging databases 104 may be identical for each source system 102. The purpose of the pre-staging database 104 is to provide a temporary storage area where source data is checked and formatted prior to be loaded into the staging area 112.

Once the data is checked, formatted and loaded onto the pre-staging database 104, the data will undergo an ETL process via ETL processor 105. This ETL processor 105 extracts data from the one or multiple pre-staging databases 104, performs a data transformation to the data based on a set of business rules and then loads the ETL processed data into a local staging database 112. The ETL process between these two stages are responsible for “change data capture”, data cleaning, data unification and transformation into data warehouse like structures.

To achieve these ends, the ETL process may contain a customizable and pre-built set of ETL libraries 107 to move data from one state of processing to the next. The ETL libraries are formed in collaboration with the personal knowledge about the source system database structures and include a data mapping phase 107.

The ETL library 106 may also contain a “change data capture” module that supports delta processing for the slowly changing dimensions. This is accomplished by allowing the ETL 105 to introduce three additional types of attributes for the source data. These attributes are used in the “change data capture” process and later for a “data versioning” process.

In order to uniquely identify records and detect changes, hashing algorithms are used within the ETL processor 105 to create keys that are stored within the global data warehouse 114. The “change data capture” module may use a collision-free hashing algorithm to perform the hashing. That is, during the process of loading the source data to the local staging area 112, a set of hash keys are generated, e.g., Natural Key Hash Source (Hash NK Source), Natural Key Hash (Hash NK) and Hash Full.

Natural Key Hash NK Source (Hash NK Source): Each reference or dimensional entity contains a clear text of the natural key (NK) that represents a unique instance of an entity in the data warehouse table. The Hash NK Source can correspond to one or more attributes of the source tables. In the case where there are more than one attribute, the source entities' attributes are concatenated to form a composite Hash NK Source.

Natural Key Hash (Hash NK): The Hash NK is created to uniquely identify source records (i.e., natural key of the data). The Hash NK is also used to maintain the integrity of the data relationships based on the natural keys defined within the source system. Each reference or dimensional entity contains a binary hash of the natural key (Hash NK Source) that represents a unique instance of the entity in the data warehouse table. The Hash NK is also used to represent a relationship (one-to-many and many-to-many) between the entities in the data warehouse.

Hash Full: The Hash Full is created for the entire record (all non-key attributes). The Hash Full together with Hash NK is used to detect and allow the process to version the correct record for that change. Each reference or dimensional entity contains a binary hash of all non-key attributes that are tracked for changes. This hash value is used to compare records and perform efficient change detection.

In other words, the ETL processor 105 computes and populates Hash NK Source, Hash NK and Hash Full attributes for each row in a dimension table. For any child dimensions or the associative entities, the ETL also populates the Hash NK Source for its parent tables.

For the purpose of describing this invention there are three types of entities in a data management system: parent (or base), child and associative entity.

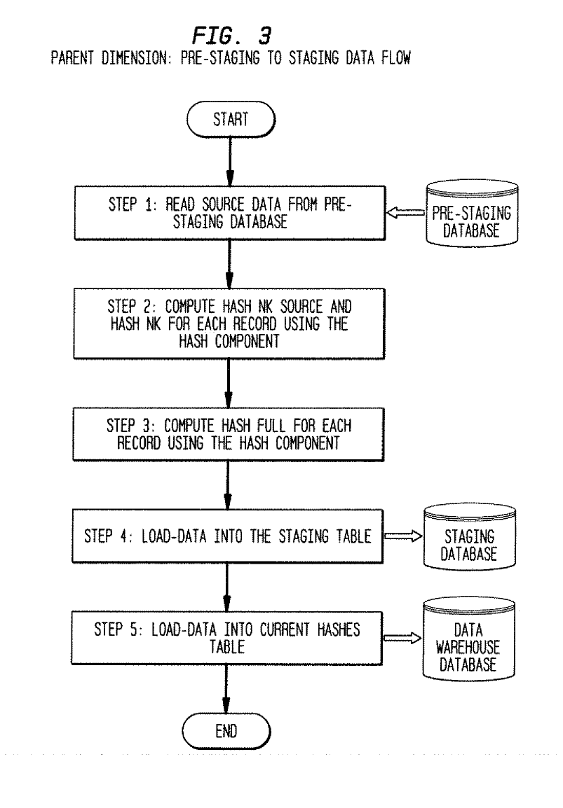

FIG. 3 outlines the data flow for parent dimension processing. During this stage, in step 1, the pre-staging database 104, using an ETL processor 103, extracts the source data from a source system 102. In Step 2, the ETL processor 105 computes a Hash NK Source and Hash NK for each record extracted from the source system 102 using a hashing algorithm. In Step 3, the ETL processor 105 computes a Hash Full for each record extracted from the source system 102 using the hashing algorithm. In Step 4, the transformed data is loaded into a staging database 112 and, in Step 5, for each parent dimension the Current Hashes table is populated which is used for loading the data into the data warehouse database 114, as will be discussed more fully below. Now each parent dimension record will be represented by a unique set of hash values.

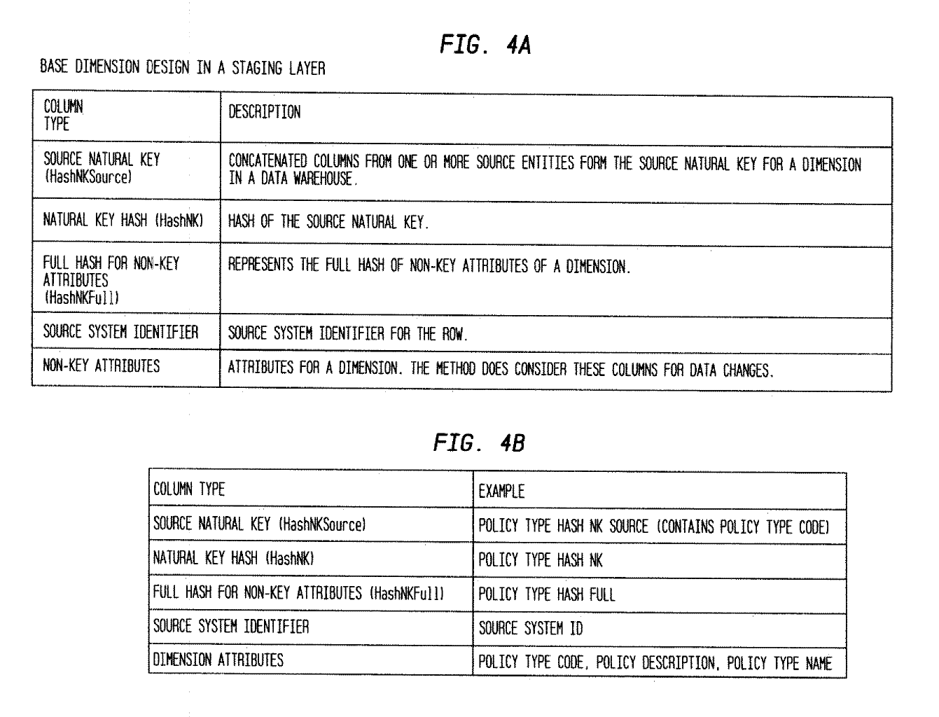

FIGS. 4a-b show examples of data structures for parent dimension in the staging layer. FIG. 4a shows a base dimension design in a staging layer. The design may include column types that may appear with data record and a description of such column types. FIG. 4b shows an example of the types of data that may be associated with the column types.

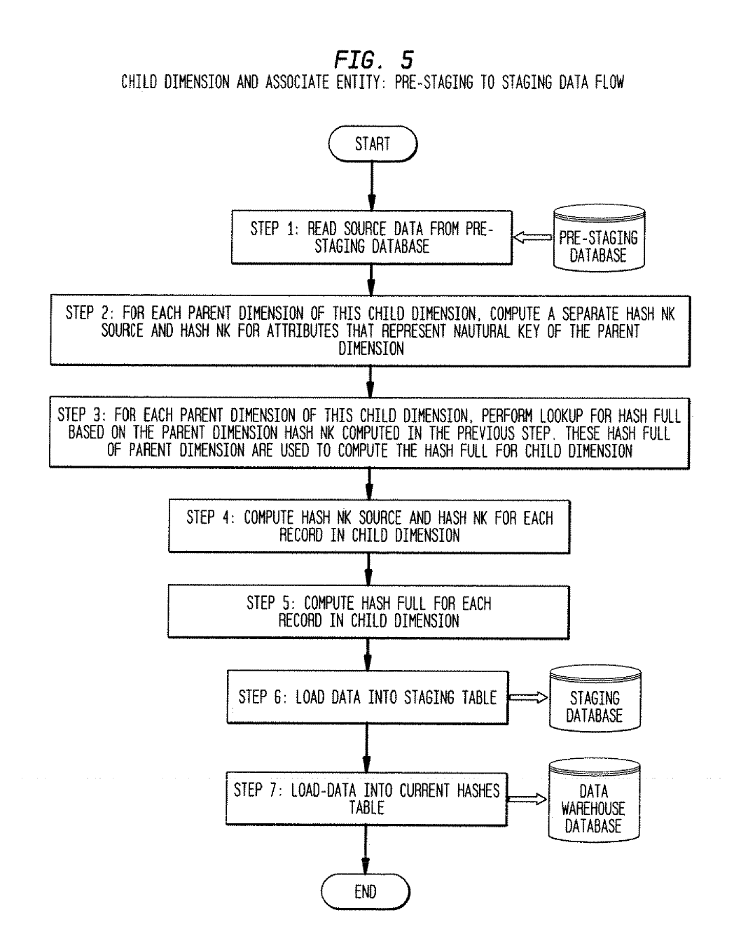

FIG. 5 outlines the data flow for child dimension and associative entity processing. During this stage, in step 1, the pre-staging database 104, using an ETL processor 103, extracts the source data from a source system 102. In Step 2, the ETL processor 105 computes a Hash NK Source and Hash NK for attributes that represent the natural key of the parent dimension. In Step 3, the ETL processor performs a lookup for Hash Full based on the parent dimension Hash NK computed in the previous step. In Step 4, the ETL processor computes a Hash NK Source and Hash NK for each record of the child dimension or associative entity. In Step 5, the ETL processor 105 computes a Hash Full for each record of the child dimension or associative entity. In Step 6, the transformed data is loaded into a staging database 112. In Step 7, for each parent dimension the Current Hashes table is populated which is used for loading the data into the data warehouse database 114, as will be discussed more fully below. Now each child dimension or associative entity record will be represented by a unique set of hash values in a data warehouse.

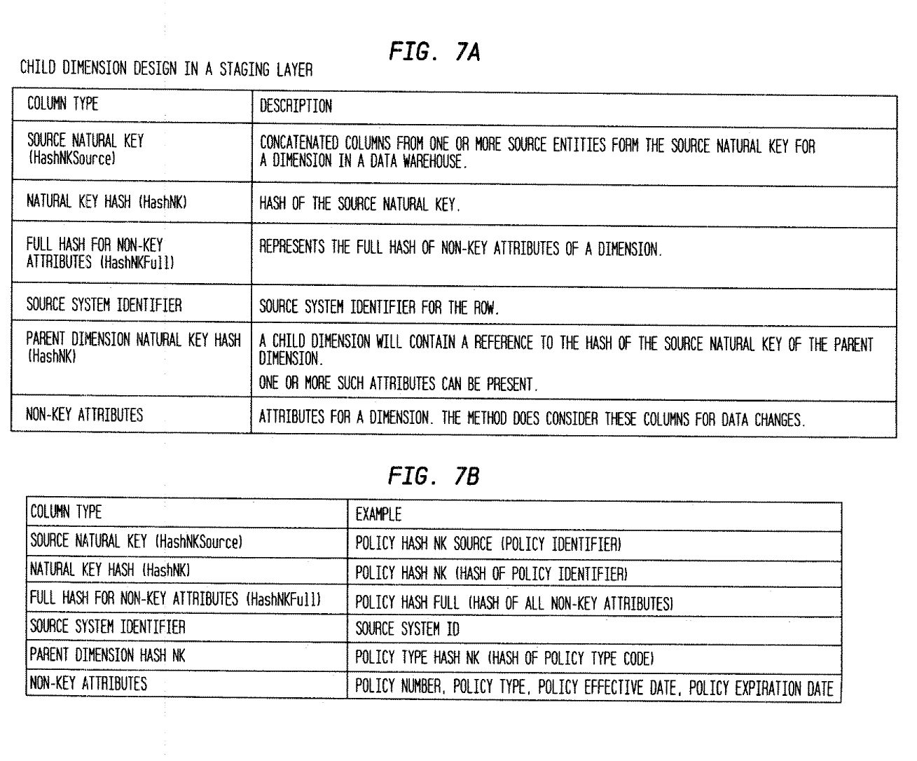

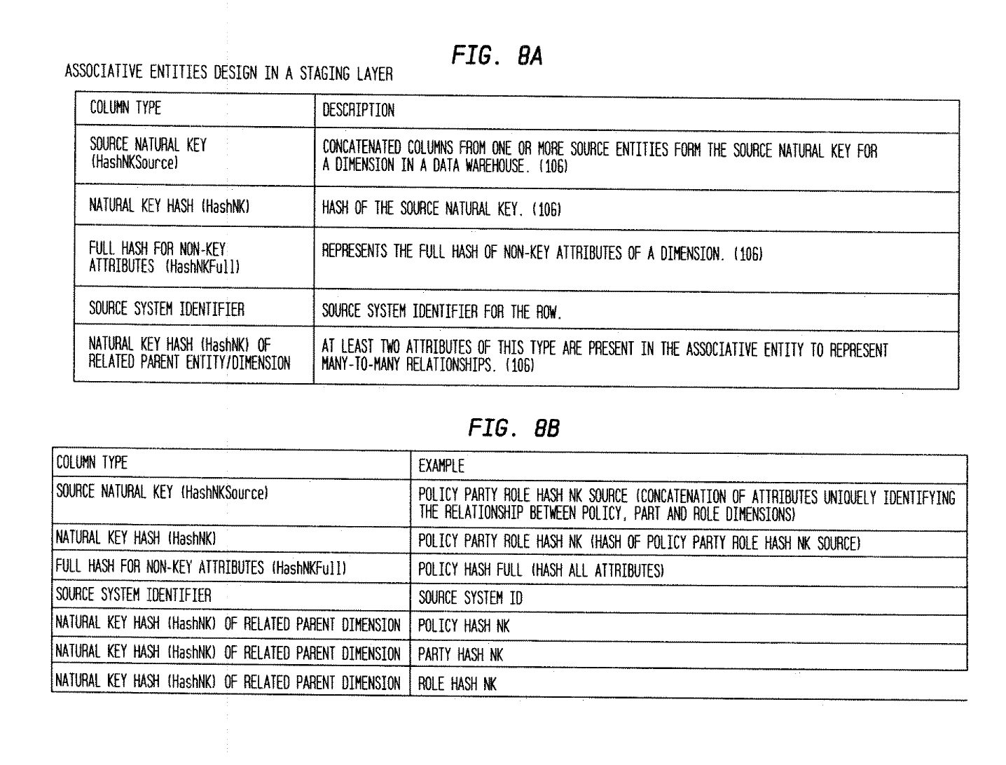

FIG. 7a shows a child dimension design in a staging layer. The design may include column types that may appear with a data record and a description of such column types. FIG. 7b shows an example of the types of data that may be associated with the column types. FIG. 8a shows an associative entity dimension design in a staging layer. The design may include column types that may appear with a data record and a description of such column types. FIG. 8b shows an example of the types of data that be associated with the column types

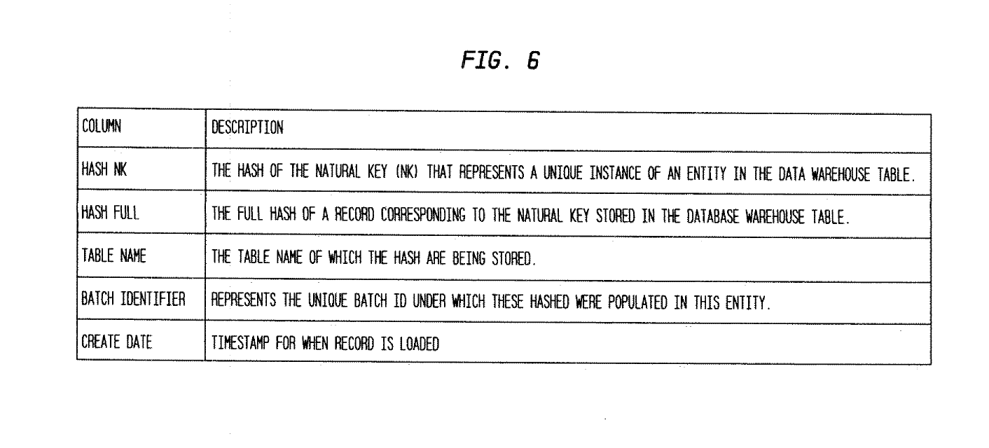

During the above processes, as noted earlier, the ETL processor 105 also populates a Current Hash table, FIG. 6, so that at the end of loading the staging area the Current Hashes table should contain: Table Name, Natural Key Hash, Hash Full, Batch Identifier and Creation Date for every dimensional related table (parent, child or associative entity).

Once the source-to-pre-staging ETL process is complete, the data is sent to the middle tier 111. Specifically, the transformed data from the pre-staging database 104 is loaded into a local staging database 112. The local staging database 112 exists for each source system 102 and acts as a storage area where the data is again formatted so that it will be easier to synchronize in a global data warehouse 114. The local staging databases 112 may be populated with the data from the source systems 102 on a regular schedule (e.g., daily, weekly, ect.), an irregular schedule or as set by the user.

Once loaded into the local staging database 112, the data will undergo another ETL process 113 so that the data may be formatted and organized so as to populate a global data warehouse 114. The global data warehouse 114 is the central database where information from each of the source systems 102 is loaded. The global data warehouse 114 may be composed of data from each source system 102 and contain both local and global values for the data, if necessary.

The staging-to-data warehouse ETL process 113 is responsible for maintaining the slowly changing dimensions. The ETL process 113 may include formatting the source data through the use of a global reference database 116. The global reference database 116 is composed of data that is fed from a customer's corporate data source and may provide consistency, control and stewardship of the data across source systems.

The staging-to-data warehouse ETL process 113 also presents an efficient “change data capture” method that can be applied to any reference or dimension table in a data warehouse 114 by including a data versioning process that ensures the most current data records are loaded into the data warehouse and the changes are tracked over time.

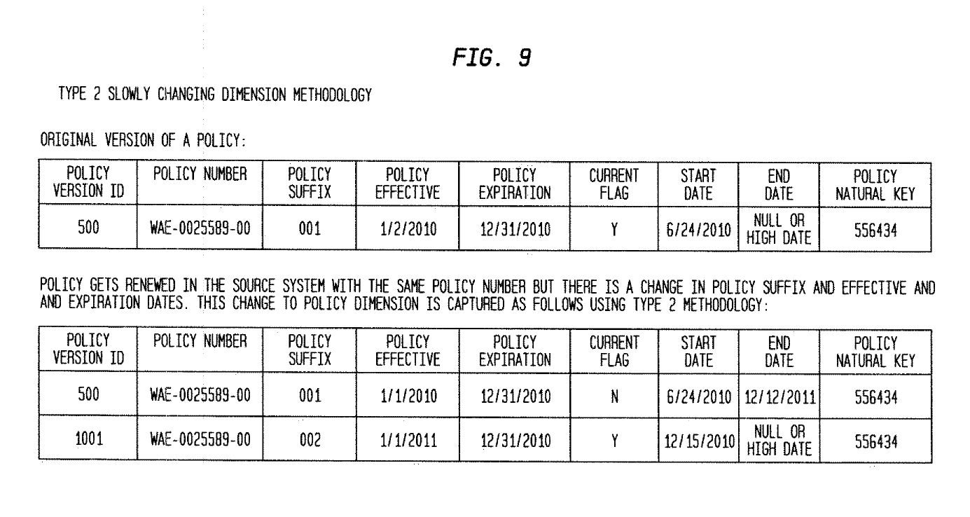

Typically, in conventional Type 2 SCD, the detection of change between two records (the incoming record and its corresponding existing target record) is based on a natural key which is stored in the data warehouse. FIG. 9 is an example of a conventional SCD methodology. Changes are detected by comparing every field of the incoming record with every field of the corresponding existing record. Specifically, for a Type 2 dimension, the load process searches the target table for records having a natural key value identical with the key value of the record to be loaded. At this point, one of the following actions is taken: (1) if no such record is found in the table, the incoming record is added to the table with indicators to indicate the current version, (2) if a current version of the record is identical (same natural key value and all attribute values) to the incoming record, and is found in the target table, the incoming record is rejected and no change is made to the table and (3) if a current version of the record with the same primary key value is found in the target table but at least one value of one the attributes differs from the value of the corresponding attribute of the incoming record, a new version of the record is added to the target table. While this approach is effective for a small volume of data, it is not efficient for large volumes of data.

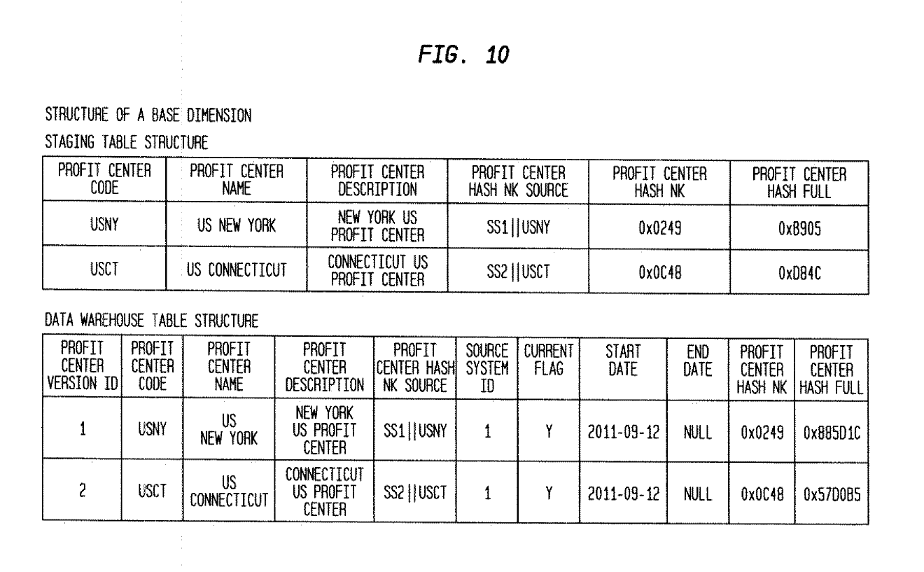

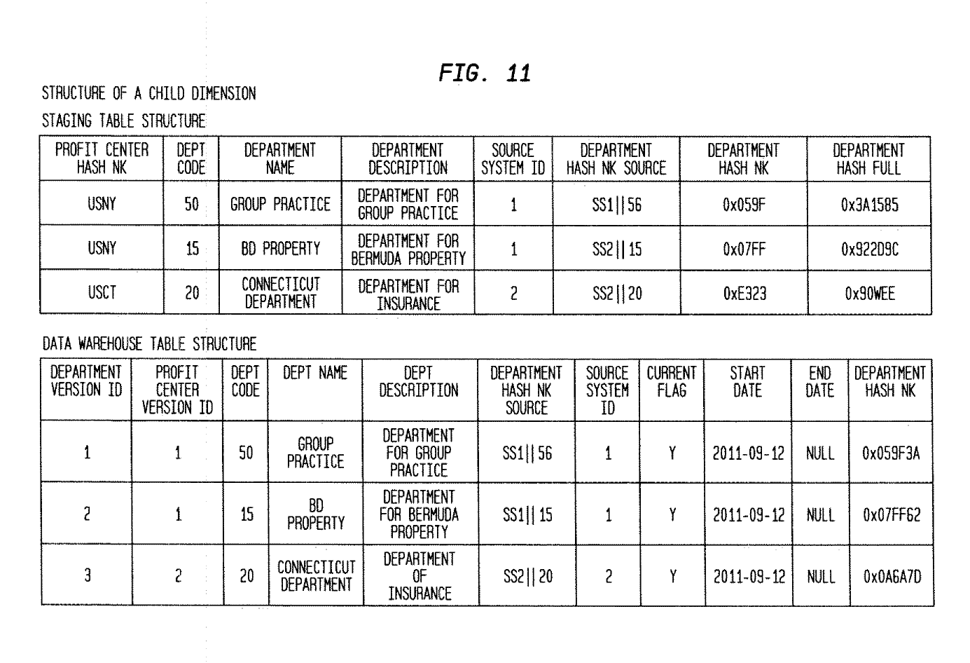

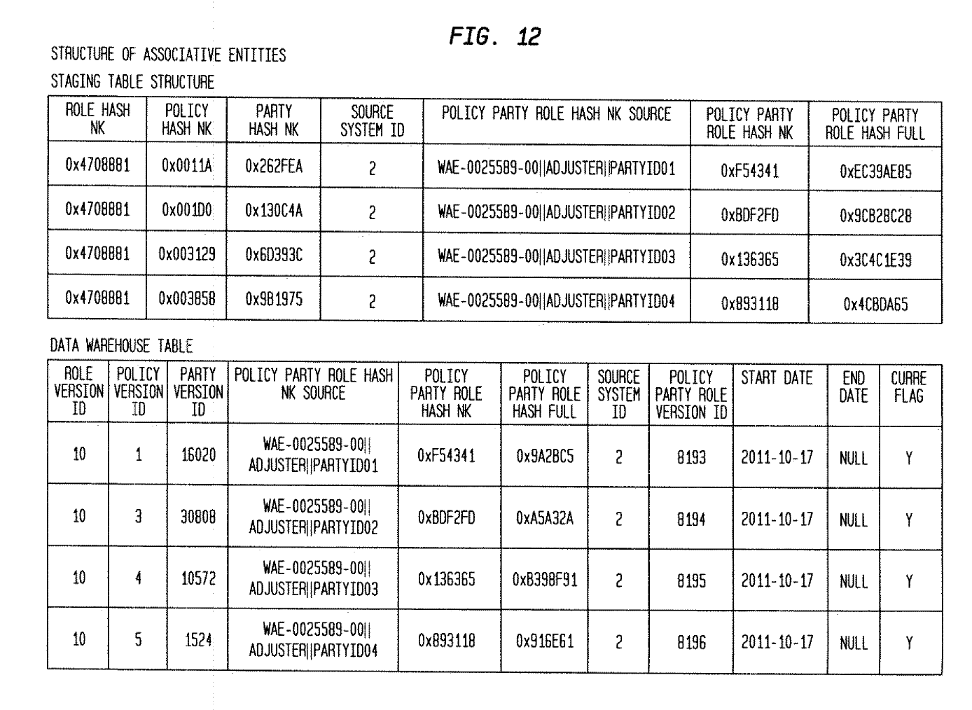

The disclosed technology provides a method based on data hashing techniques that is capable of detecting any changes between two near identical data sets and create a new version of the data set in a dimension or reference table. In other words, the disclosed technology compares the hash values for the two records to detect changes. FIGS. 10-12 show the table structure for parent, child and associative entities in the staging database.

In short, in order to update the data warehouse, a set of columns are populated using hash values provided by a collision-free hashing algorithm as discussed above. The method then, for a given natural key, compares the hash values in the staging table with the hash values previously stored in the data warehouse. If a single character between the two records is changed, hashes for the two records will be different and thus the record should be updated. This method can be implemented in any ETL tool with bulk processing techniques for loading the data. It was found that the disclosed bulk processing, as compared to conventional row-by-row processing, significantly improves the performance of loading and updating data.

In more detail, a reference or dimension table will consist of a natural key column (Hash NK and Hash NK Source). Additionally, a reference or dimension table in a data warehouse is mapped to one or more tables in the source system. The invention defines the concept of a unified natural key for the target table. One or more attributes from the source entities will contribute to the natural key. In case of a composite natural key, as compared to the simple natural key, the source attributes are concatenated using a delimiter. The business rule for a natural key is that it cannot change and is capable of being uniquely identified in a dimension.

Before moving the data into the data warehouse, the ETL process compiles a table that compares the current hash values of the staging tables with the previous hash values of the data warehouse. This table is called a new hash table and is capable of tracking any changes between the current and previous hash values.

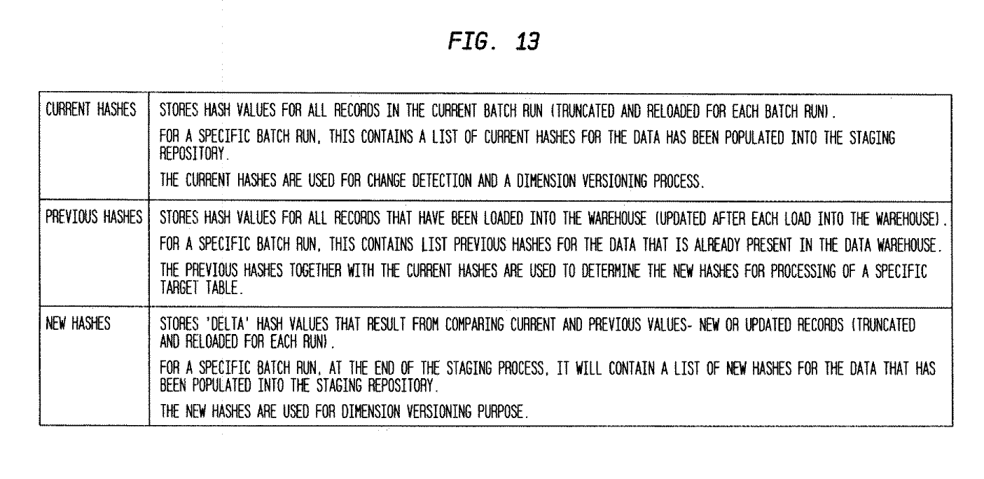

FIG. 13 is shows the new hash table and shows the current hashes, the previous hashes and if any changes occurred between the hashes. The content of new hash values are to a set-theoretic difference of current hashes values and previous hash values. The set-theoretic difference operation, as compared to the conventional row comparison of each dimension between the staging and the warehouse, is more efficient to determine the data (new or changed) to be processed for each reference or data warehouse table. At the end of the ETL process, a list will be formed containing which dimensions changed since the last update of the data warehouse. Based on these new hash values, the global data warehouse will be updated accordingly.

That is, the new hash values (dimensions that changes since the last update) present in various staging databases (assuming there are more than one staging databases) are unified into corresponding new hash value table inside the data warehouse. As noted earlier, the new hash values contain the Natural Key Hash and Hash Full of rows that are either changed or are new since the previous load of data warehouse.

For background, a dimension can have a one-to-many or a many-to-many relationship with other dimensions. This creates a dependency among the dimensions and mandates an order in which the dimensions must be processed. The parent dimensions are processed first followed by its child dimensions. The relationship between multiple dimensions is maintained in associative entities and these entities are processed after all the entities participating in this relationship have completed its respective processing. This dependency tree is traversed and dimensions are loaded until the leaf level dimensions are completely processed.

Further, a data warehouse data model will be typically based on: a normalized model (3NF), a pure dimensional, a snowflake or a hybrid (combination of all previously noted model types). Irrespective of the model type, the disclosed technology can be used for any reference or dimension entity present in the data warehouse. The entities (normalized, dimensional or snowflake) in a data warehouse participate in parent-child relationships (one-to-many) or through associative entities (many-to-many).

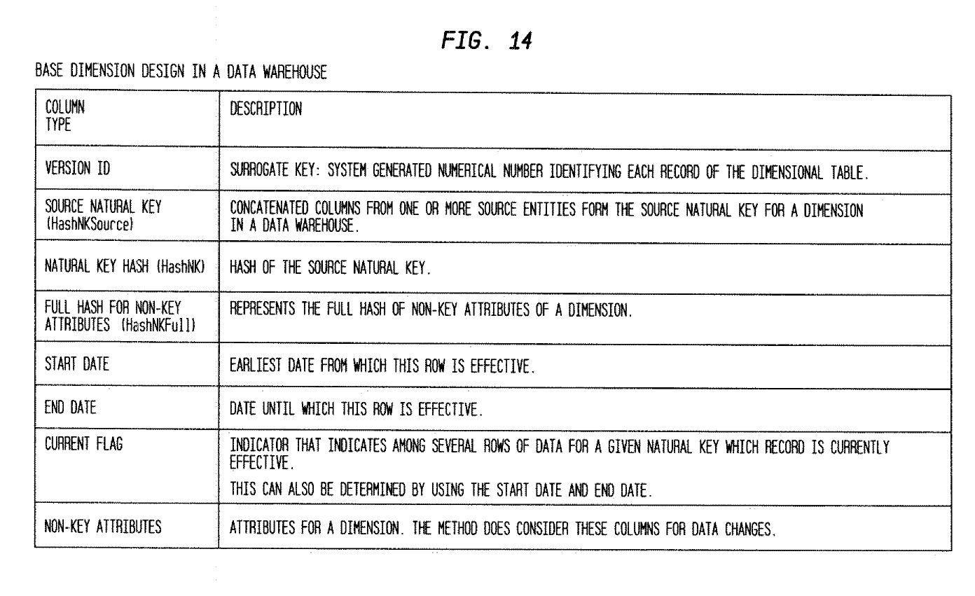

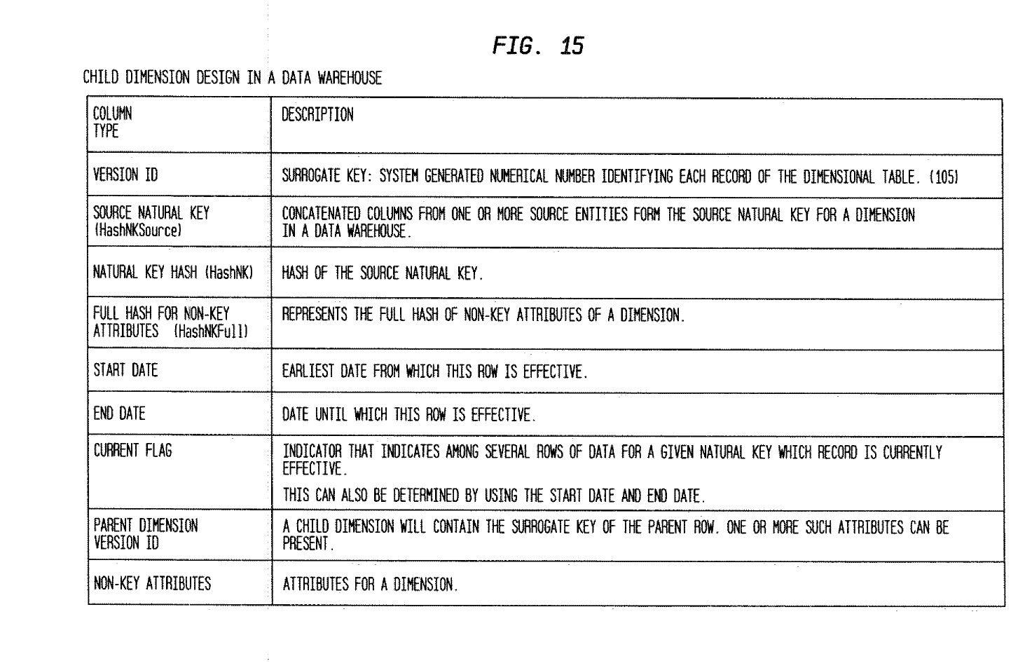

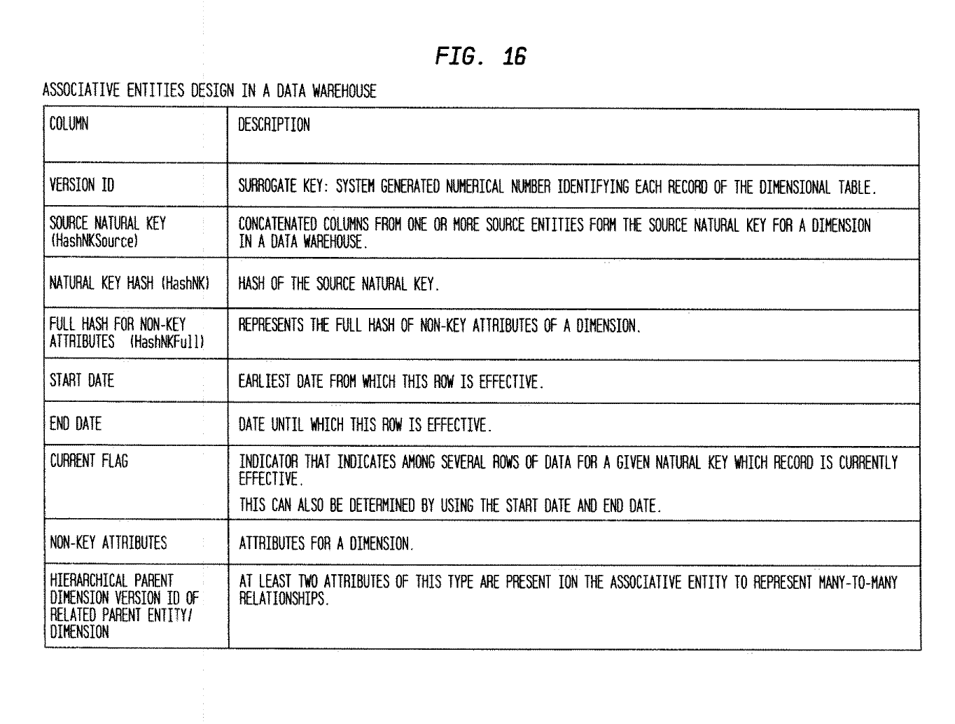

The disclosed technology introduces three patterns to populate reference or dimension tables in the data warehouse. The pattern is selected based on the type of table (parent or child or associative). FIGS. 14-16 show the dimension design structure for the parent, child and associative entities in the data warehouse.

Parent Dimension Processing: The processing of all top level reference or dimension entities that are not a child of any other entity is based on using the new hashes table. The new hashes provide the rows that are either new or have changed since the last run. All the rows (new or changed) from the staging table are directly inserted into the target dimensional table in the data warehouse.

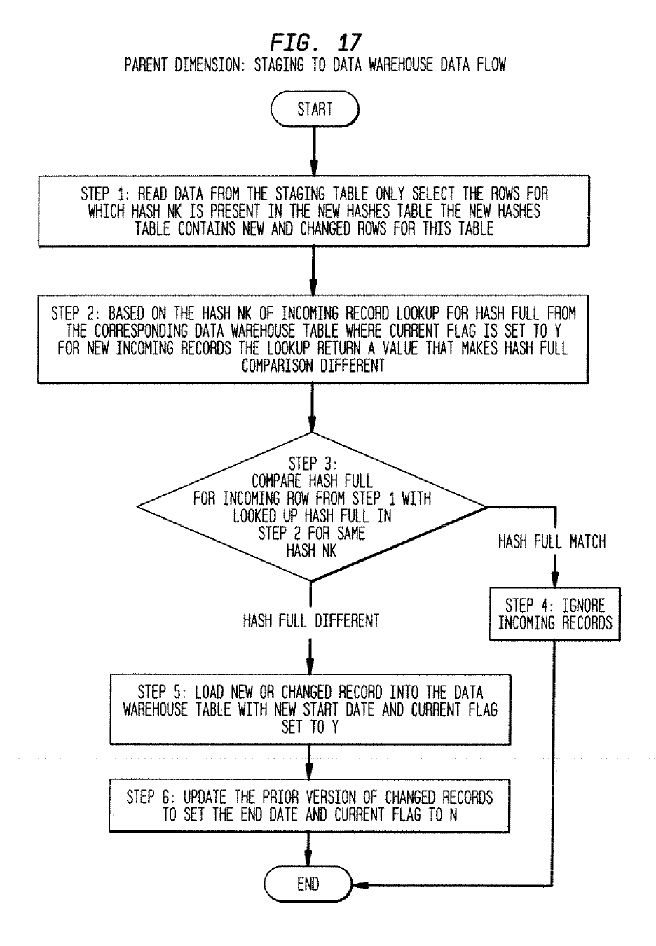

FIG. 17 shows a flow chart showing the movement from the staging database to the data warehouse for a parent dimension. Only data that has changed or new will be moved into the data warehouse. In Step 1, the system will read the Hash NK for the incoming records stored in the new hash table for the staging database. In Step 2, the system will lookup the corresponding Hash Full associated with Hash NK in the data warehouse and will find the row where current flag is set to “Y.” In Step 3, the system compares the Hash Full for the record stored in the staging database with a Hash Full for the corresponding record stored in the data warehouse. If the Hash Full for the two corresponding records is identical, the system will proceed to Step 4 and will ignore the record stored in the staging database. If the Hash Full for the two records is different, the system will proceed to Step 5 where the new record will be added to the warehouse and the newly added row will have a Start Date column being set to the current date (and time if needed), End Date is set to “NULL” or an arbitrary time in the future and the Current Flag is set to ‘Y’. In Step 6, towards the end of processing each dimension, the previous version of rows that were changed in this load are expired by updating the End Date to the current date (and time if needed) and Current Flag is set to ‘N’.

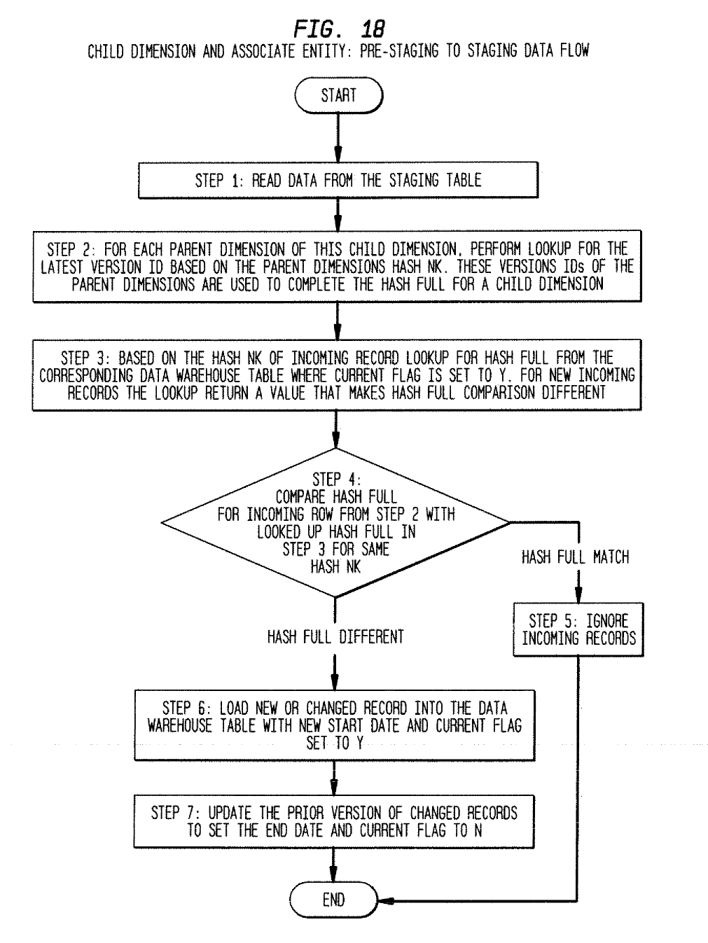

Child Dimension Processing: FIG. 18 shows a flow chart showing the movement of data from the staging database to the data warehouse for a child dimension. A new version of a child reference or a dimension entity is created whenever the process detects changes to one or more attributes of the entity. In addition, a child dimension can also get versioned because one or more of its parent dimensions have changed and a new version needs to be created for a child dimension to relate it with the parents' new version.

In Step 1, data is read from new hash table in the staging table. In Step 2, the system performs a look up based on the Natural Key Hash (Hash NK) of the parent dimension to obtain the latest version (using Current Flag) of the parent dimension. The look up returns the Version ID (a surrogate key in a data warehouse) of the parent row. This step is performed for each relationship attribute present in the child dimension. In Step 3, the system will lookup the Hash Full for the child dimension in the data warehouse associated with the latest version of the parent dimension and will find the row where current flag is set to “Y.” In Step 4, for a given natural key (Hash NK) of a row in the staging table, the process compares the computed Hash Full with the Hash Full of corresponding current row (Current Flag=‘Y’) present in the data warehouse table. If the comparison results in a match, the process proceeds to Step 5 and no action is performed and the incoming record in the staging table is rejected. If they do not match, the process proceeds to step 6 and a new row is created in the target child dimension table in the data warehouse. For the newly added row, the Start Date column is set to the current date (and time if needed), and the End Date is set to “NULL” or an arbitrary time in the future and the Current Flag is set to ‘Y’. Towards the end of processing each dimension, in Step 7, the previous version of rows that were changed in this load are expired by updating the End Date to the current date (and time if needed) and Current Flag is set to ‘N’.

Associative Entity Processing: The processing for associative entities is similar to child dimension processing.

In this section we have described a method for a “change data capture” to maintain Type 2 slowing changing dimensions in a data warehouse. It is often preferable and desirable for the source system to hand over only the changed data to avoid errors. This disclosure provides an efficient pattern to accomplish the change detection and maintaining the Type 2 dimensions in a data warehouse.

The data loaded on the global data warehouse 114 is stored and organized to be processes through to a global data mart 118. That is, once the data is loaded into the global data warehouse 114, the data undergoes another ETL process 115. This warehouse-to-mart ETL 115, reorganizes and summaries data from the global data warehouse 114 for optimizing reporting. The warehouse-to-mart ETL library may contain a set of modules that loads the data from the global data warehouse to the global data mart. The ETL library may push the conformed data within the normalized global data warehouse to the dimensional global data mart.

Once the ETL process 115 is complete, the data is loaded into the data mart 118. The data mart reorganizes and summarizes data from the global data warehouse 114 for optimized reporting. That is, the data in the data mart is truncated and all data is reloaded based on the data versioning stored within the global data warehouse. The data mart 118 provides a data structure that consolidates data, provides an underlying data architecture, efficiently supports commonly performed queries and provides extensively for adding additional data sources, measures, dimensions, attributes or calculations.

Also, in order to accurately maintain the relationships between the fact tables and the dimension tables, all dimension tables are loaded first. As dimensions are loaded, each dimension member is assigned a surrogate key value as its primary key and each dimension member is assigned a source ID value indicating the source of the dimensions member's value. The fact tables are loaded after all the dimensions have been populated. During the fact table load the dimension member natural key and source system ID combinations facilitate lookups to retrieve dimension member surrogate keys. After all lookups are complete, the fact data are inserted into the target fact tables.

After the data is stored in the data mart, a multi-dimensional cube 119 is used to allow a user to efficiently and effectively use the data. The multi-dimensional cube 119 is a pre-aggregated data structure that allows users to analyze measures by associated dimensions. The multidimensional cube allows users to efficiently and effectively, slice, dice, drill up and drill down on data without requiring users to have familiarity with the underlying data infrastructure. The cube manages different types of data relationships to vary levels of detail. The pre-aggregation of data and pre-defined relationships allow the cube to retrieve data quickly when queried.

The data is presented to the user on the presentation layer 121. The presentation layer consists of highly interactive and user-friendly computing device 130 that may incorporate a display. The presentation layer 121 visualizes various business attributes, e.g., dashboards 122, analytics 124 and reports 126.

In summary, the disclosed technology presents: (1) a unified “change data capture” method to detect changes between two records, the incoming record and the corresponding record in the target table based on the natural key already present in the data warehouse (The comparison is performed by comparing the binary hash of the two records. The binary hash is computed by the proprietary hashing component using a collision-free hash generation algorithms), (2) inclusion of additional attributes on each reference or dimension table in the staging and data warehouse databases (These attributes are used for change detection and outlines a pattern across all reference or dimension tables. This pattern also facilitates writing generic routines to implement an efficient Type 2 methodology), (3) various types of reference or dimensional tables present in a typical data warehouse and a generic Type 2 methodology for processing each type of dimension and (4) data structures (tables) in a data warehouse that are used to perform set-theoretic operations (such as MINUS) to determine in bulk the data that has changed.

It is noted that the systems and methods disclosed herein may be implemented on various types of computer architectures, such as for example on a single general purpose computer or workstation, or on a network (e.g., local area network, wide area network, or internet), or in a client-server configuration, or in an application service provider configuration. Also, the system's and method's data (such as hierarchical data) may be stored as one or more data structures in computer memory and/or storage depending upon the application at hand. The systems and methods may be provided on many different types of computer readable media including instructions being executable by a computer to perform the system and method operations described herein. The systems and methods may also have their information transmitted via data signals embodied on carrier signals (e.g., radio frequency carrier signals) or other communication pathways (e.g., fiber optics, infrared, etc.).

The computer components, software modules, functions and data structures described herein may be connected directly or indirectly to each other in order to allow the flow of data needed for their operations. It is also noted that a module includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The computer components may be located on a single computer or distributed across multiple computers depending upon the situation at hand.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method for updating a slowly changing dimension table, wherein the dimension table is populated with data records extracted from at least one source system with each data record being associated with at least one identifying hash value and at least one attribute hash value, comprising:
computing a set of hash values for an incoming set of data records extracted from the at least one source system, the incoming set of hash values including at least one identifying hash value and at least one attribute hash value for each data record contained in the incoming set of data records;
searching the dimension table for records having an identifying hash value identical with the identifying hash value of the incoming set of data records;
comparing the attribute hash values of the records having identical identifying hash values; and
updating the dimension table with the incoming data record if the attribute hash values for the records having identical identifying hash values are different.

2. The computer-implemented method of claim 1 wherein the dimension table is a Type 2 slowly changing dimension table.

3. The computer-implemented method of claim 1 wherein the computing step is performed by a collision-free hashing algorithm.

4. The computer-implemented method of claim 1 wherein the at least one identifying hash value is a hash of a source natural key for a dimension and the at least one attribute hash value is a hash of non-key attributes of a dimension.

5. The computer-implemented method of claim 1 further comprising:
populating a current hash table, a previous hash table and a new hash table.

6. The computer-implemented method of claim 5 wherein the current hash table stores hash values for all records associated with the incoming data record.

7. The computer-implemented method of claim 6 wherein the previous hash table stores hash values for all records populated on the dimension table.

8. The computer-implemented method of claim 7 wherein the new hash tables stores the change in hash values that result from the comparison of the current hash table with the previous hash table.

9. The computer-implemented method of claim 8 further comprising:
compiling a list using the new hash table wherein a change was shown between the current hash value and the previous hash value.

10. The computer-implemented method of claim 9 wherein the searching step uses the list associated with the new hash tables for searching the dimension table.

11. A system for updating a slowly changing dimension table, wherein the dimension table is populated with data records extracted from at least one source system with each data record being associated with an identifying hash value and an attribute hash value, comprising:
one or more processors;
one or more computer-readable storage mediums containing instructions configured to cause the one or more processors to perform operations including:
computing a set of hash values for an incoming set of data records extracted from the at least one source system, the incoming set of hash values including at least one identifying hash value and at least one attribute hash value for each data record contained in the incoming set of data records;
searching the dimension table for records having an identifying hash value identical with the identifying hash value of the incoming set of data records;
comparing the attribute hash values of the records having identical identifying hash values; and
updating the dimension table with the incoming data record if the attribute hash values for the records having identical identifying hash values are different.

12. The system of claim 11 wherein the dimension table is a Type 2 slowly changing dimension table.

13. The system of claim 11 wherein the computing step is performed by a collision-free hashing algorithm.

14. The system of claim 11 wherein the at least one identifying hash value is a hash of a source natural key for a dimension and the at least one attribute hash value is a hash of non-key attributes of a dimension.

15. The system of claim 11 further comprising:
populating a current hash table, a previous hash table and a new hash table.

16. The system of claim 15 wherein the current hash table stores hash values for all records associated with the incoming data record.

17. The system of claim 16 wherein the previous hash table stores hash values for all records populated on the dimension table.

18. The system of claim 17 wherein the new hash tables stores the change in hash values that result from the comparison of the current hash table with the previous hash table.

19. The system of claim 18 further comprising:
compiling a list using the new hash table wherein a change was shown between the current hash value and the previous hash value.

20. The system of claim 19 wherein the searching step uses the list associated with the new hash tables for searching the dimension table.

21. A computer-program product for updating a slowly changing dimension table, wherein the dimension table is populated with data records extracted from at least one source system with each data record being associated with an identifying hash value and an attribute hash value, the product tangibly embodied in a machine-readable storage medium, including instructions configured to cause a data processing apparatus to:
compute a set of hash values for an incoming set of data records extracted from the at least one source system, the incoming set of hash values including at least one identifying hash value and at least one attribute hash value for each data record contained in the incoming set of data records;
search the dimension table for records having an identifying hash value identical with the identifying hash value of the incoming set of data records;
compare the attribute hash values of the records having identical identifying hash values; and
update the dimension table with the incoming data record if the attribute hash values for the records having identical identifying hash values are different.

22. The computer-program product of claim 21 wherein the dimension table is a Type 2 slowly changing dimension table.

23. The computer-program product of claim 21 wherein the computing step is performed by a collision-free hashing algorithm.

24. The computer-program product of claim 21 wherein the at least one identifying hash value is a hash of a source natural key for a dimension and the at least one attribute hash value is a hash of non-key attributes of a dimension.

25. The computer-program product of claim 21 further including instructions configured to cause a data processing apparatus to:
populate a current hash table, a previous hash table and a new hash table.

26. The computer-program product of claim 25 wherein the current hash table stores hash values for all records associated with the incoming data record.

27. The computer-program product of claim 26 wherein the previous hash table stores hash values for all records populated on the dimension table.

28. The computer-program product of claim 27 wherein the new hash tables stores the change in hash values that result from the comparison of the current hash table with the previous hash table.

29. The computer-program product of claim 28 further including instructions configured to cause a data processing apparatus to:
compile a list using the new hash table wherein a change was shown between the current hash value and the previous hash value.

30. The computer-program product of claim 29 wherein the searching step uses the list associated with the new hash tables for searching the dimension table.
